(19) United States
(12) Patent Application Publication
(10) Pub. No.: US 2026/0214086 A1
(43) Pub. Date: Jul. 23, 2026

(54) Validating Certificates for Resource-Constrained Devices using an OCSP Service

(71) Applicant: DigiCert, Inc., Lehi, UT (US)

(72) Inventors: Atul Gupta, Cupertino, CA (US); Avesta Hojjati, Austin, TX (US)

(73) Assignee: DigiCert, Inc., Lehi, UT (US)

(21) Appl. No.: 19/032,695

(22) Filed: Jan. 21, 2025

(51) Int. Cl. H04L 9/40

(52) U.S. Cl. CPC H04L 63/0823

(57) ABSTRACT

Systems and methods are provided for validating certificates of a certificate chain and validating Intermediate Certificate Authorities (ICAs). According to one implementations, a centralized certificate validation server is configured to receive a certificate status request from a resource-constrained device, wherein the certificate status request inquires as to whether security measures are in place to allow the resource-constrained device to securely perform an intended communication with a selected Intermediate Certificate Authority (ICA). The centralized certificate validation server is further configured to check a list of valid certificates and trusted ICAs with respect to a domain in which the resource-constrained device is deployed. Also, based on checking the list, the centralized certificate validation server is configured to respond to the resource-constrained device as to whether the resource-constrained device can continue with the intended communication with the selected ICA.

### FIELD OF THE DISCLOSURE

The present disclosure relates generally to network security in communication systems. More particularly, the present disclosure relates to systems and methods for determining the validity of digital certificates and Intermediate Certificate Authorities (ICAs) using an Online Certificate Status Protocol (OCSP) service for allowing resource-constrained devices to securely communicate over a network.

### BACKGROUND

The growth of network communication systems has included the increased use of various types of “resource-constrained devices,” such as embedded devices, Internet of Things (IoT) devices, etc. These resource-constrained devices (or simply “constrained devices”) often operate with minimal storage capacity and limited computational power. It should be understood, however, that these limitations may create significant challenges for securing communications based on Public Key Infrastructure (PKI), particularly since these devices may not be able to store multiple trusted issuing certificates for different Certificate Authorities (CAs). When these resource-constrained devices need to trust or validate multiple possible PKI handshakes, signatures, or certificate chains, they may simply lack the memory or processing capability to handle all the necessary Intermediate Certificate Authorities (ICAs). The constrained nature of these devices, coupled with the need to accommodate evolving security requirements and certificate management practices, poses a formidable barrier to maintaining security, compliance, and uninterrupted operations over the lifetime of the devices.

### BRIEF SUMMARY

The present disclosure relates to systems and methods for validating digital certificates as well as validating Intermediate Certificate Authorities (ICAs) associated with a certificate chain used for securing a domain in which one or more resource-constrained devices are deployed. In some embodiments, the present disclosure focuses on a centralized certificate validation server that is specifically configured to perform certain functionality with respect to the certificate chain. In addition, in some other embodiments, the present disclosure focuses on one or more resource-constrained devices that are specifically configured to operate with the centralized certificate validation server to inquire about the security of communicating with an ICA in the certificate chain. The present disclosure is directed to a) methods having a number of steps, b) processing devices configured to implement the steps, c) cloud services configured to implement the steps, and d) non-transitory computer-readable media storing instructions for programming one or more processors to execute the steps.

According to one implementation, a first method associated with the centralized certificate validation server includes a step of receiving a certificate status request from a resource-constrained device. Specifically, the certificate status request inquires as to whether security measures are in place to allow the resource-constrained device to securely perform an intended communication with a selected Intermediate Certificate Authority (ICA). In addition, the first method includes a step of checking a list of valid certificates and trusted ICAs with respect to a domain in which the resource-constrained device is deployed. Based on the step of checking the list, the first method further includes a step of responding to the resource-constrained device as to whether the resource-constrained device can continue with the intended communication with the selected ICA.

According to various embodiments of this method, the certificate status request may be related to an Online Certificate Status Protocol (OCSP) call. In some embodiments, the method may further include a step of performing a preliminary lookup action to determine the certificate status of a certificate chain associated with a root Certificate Authority (root CA) and one or more ICAs configured for servicing the domain. The method may also include a step of storing information obtained during the preliminary lookup action in a repository that is configured to record the list of valid certificates and trusted ICAs. The method 80 may also include a step of performing periodic updated lookup actions to update the certificate status of the certificate chain.

The certificate status request, for example, may be part of a Transport Layer Security (TLS) communication. Also, the step of checking the list may be performed independently of a Certificate Revocation List (CRL). This first method may further include a step of checking whether the selected ICA is part of the domain in which the resource-constrained device is deployed. The action of responding to the resource-constrained device may thereby allow the resource-constrained device to validate multiple PKI handshakes, signatures, or certificate chains. The method, according to some embodiments, may be implemented by the centralized certificate validation server, which may include a lookup module, a certificate coordination module, and an Online Certificate Status Protocol (OCSP) responder module. The step of responding to the resource-constrained device, according to some embodiments, may include digitally signing a certificate validation response to ensure integrity and authenticity.

According to another implementation, a second method associated with one of the resource-constrained devices includes a step of initiating a secure communication handshake with a centralized certificate validation server using a pre-stored reference to the centralized certificate validation server, whereby the secure communication handshake includes a selected Intermediate Certificate Authority (ICA). In response to receiving an indication that the selected ICA is valid, the second method further includes a step of generating a certificate status request. The second method also includes transmitting the certificate status request to the centralized certificate validation server to inquire as to whether an intended communication with the selected ICA can proceed securely. In response to receiving a go-ahead message from the centralized certificate validation server, the second method further includes a step of proceeding with the intended communication.

According to various implementations of this second method, the certificate status request may be related to an Online Certificate Status Protocol (OCSP) call. The centralized certificate validation server, for example, may be configured to generate the go-ahead message in response to determining a certificate status of a certificate chain associated with a root Certificate Authority (root CA) and one or more ICAs during a preliminary lookup procedure and/or during one or more updated lookup procedures. In some embodiments, the certificate status request may be generated independently of a Certificate Revocation List (CRL). The second method, according to some embodiments, may include a step of validating multiple PKI handshakes, signatures, or certificate chains. The method may also include a step of using the pre-stored reference to verify the authenticity of the indication that the selected ICA is valid.

In some embodiments, this method may be performed by any resource-constrained device for executing the validation procedures described in the present disclosure. In various implementations, the resource-constrained device may include a trust store that is configured to store the pre-stored reference to pin a root certificate or public key to the centralized certificate validation server. Furthermore, in some embodiments, the method 90 may include a) caching the go-ahead message for a specified period of time, and b) discarding the cached response when the specified period of time has elapsed or when memory constraints are reached. The method, in some cases, may further include verifying the authenticity of a) the indication that the selected ICA is valid and/or b) the go-ahead message. For example, this verifying of the authenticity may be performed by 1) retrieving an identifier of the centralized certificate validation server, 2) confirming that the identifier matches a pre-stored OCSP responder identifier, and 3) validating a digital signature applied to the centralized certificate validation server using a pinned certificate or public key stored in a trust store in the resource-constrained device.

According to additional embodiments, the method may further includes updating the pinned root certificate or public key for the custom OCSP responder on the constrained IoT device via an over-the-air (OTA) or physical update mechanism when the custom OCSP responder's certificate is rotated, replaced, or compromised. The method may also include generating a revocation check for the ICA at defined intervals or upon each handshake, allowing the constrained IoT device to identify any newly revoked ICA without storing a full Certificate Revocation List (CRL). Furthermore, the constrained device performing the method 90 may be configured to operate with limited memory and leverage ephemeral storage to retain only the most recent OCSP responses. Also, the constrained device may perform cryptographic operations using a lightweight algorithm, such as elliptic curve cryptography, to fit within its limited processing capability.

In some alternative embodiments, a method for managing the rollover of an ICA on a constrained (IoT) device using a centralized lookup service may include a step of pinning a root certificate or public key for a custom OCSP responder on the constrained IoT device, thereby establishing a single trust anchor. This method may also include receiving at the centralized lookup service a newly issued ICA intended to replace an existing ICA and then updating records in the custom OCSP responder to reflect trust in the newly issued ICA. This method may also include steps of publishing the updated trust information to the centralized lookup service, and then responding, by the custom OCSP responder, to any OCSP queries from constrained IoT devices, indicating that the newly issued ICA is in good standing. Furthermore, this method may include a step of facilitating continued secure communications for constrained IoT devices without requiring each device to store or update the new ICA locally.

According to this additional method, the constrained device may further be configured to mark the replaced ICA as revoked or retired within the custom OCSP responder's records. Also, this method may include issuing OCSP responses that reflect the updated status of the replaced ICA to prevent constrained IoT devices from establishing trust with it. Then, the method may include enabling immediate revocation or deprecation of the replaced ICA without requiring a direct certificate store update on each constrained IoT device.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a block diagram illustrating a network system comprising a chain of components having digital certificates for enabling secure communication, according to various embodiments.

FIG. 2 is a block diagram illustrating a network system in which a centralized certificate validation server intercedes for a group of resource-constrained devices, according to various embodiments.

FIG. 3 is a block diagram illustrating a computing system representing the centralized certificate validation server shown in FIG. 2, according to various embodiments.

FIG. 4 is a flow diagram illustrating a method for validating digital certificates in a network having resource-constrained devices, according to various embodiments.

FIG. 5 is a flow diagram illustrating a method of the centralized certificate validation server shown in FIG. 2, according to various embodiments.

FIG. 6 is a flow diagram illustrating a method of one of the resource-constrained devices shown in FIG. 2, according to various embodiments.

### DETAILED DESCRIPTION

Again, resource-constrained devices (e.g., constrained devices, embedded devices, Internet of Things (IoT) devices, etc.) may be configured with limited storage and computational capabilities. Although these limitations may be a problem in conventional security networks, the systems and methods of the present disclosure are able to utilize a “centralized certificate validation server” that is configured to provide security functionality beyond the regular capabilities of a resource-constrained device on its own. When a resource-constrained device (e.g., IoT device) intends to communicate over a certain path (e.g., over the Internet), it may be important to reduce or even eliminate various types of nefarious actions or breaches by hackers. In this respect, the centralized certificate validation server can assist the resource-constrained device for determining if the path is secure. For example, ensuring security may include determining if a digital certificate of a root Certificate Authority (root CA) and one or more Intermediate Certificate Authorities (ICAs) are valid.

Furthermore, some resource-constrained devices may be limited by an ICA “pinning” issue. That is, the resource-constrained devices may be “pinned” to a specific ICA, whereby they trust only one particular intermediate certificate in the certificate chain. Thus, any routine rollover or replacement of that ICA for security, compliance, or operational reasons could render these endpoint devices unable to establish trust. Since they might not have a mechanism (e.g., over-the-air (OTA) updates, etc.) to replace the pinned certificate with an updated one, they remain stuck on the old ICA. Over time, this inevitably leads to trust failure and an inability to communicate securely with updated or newly issued certificates.

### Certificate Chain

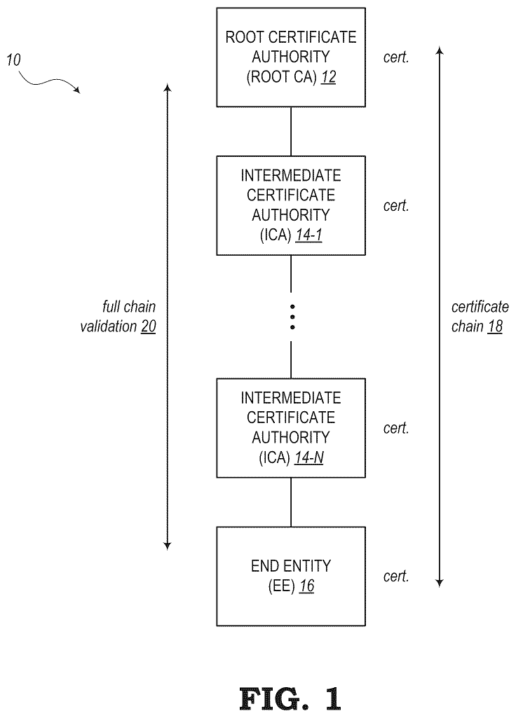

FIG. 1 is a block diagram illustrating an embodiment of a network environment 10 that may be used for ensuring that security measures are followed within a communications system. As shown, the network environment 10 includes a root Certificate Authority (root CA) 12 of a Certificate Authority (CA), which may be responsible for issuing digital certificates to websites, domains, end user devices, individuals, etc. The CA may also include one or more Intermediate Certificate Authorities (ICAs) 14-1, . . . , 14-N, which can create a digital certificate for an end entity 16 (e.g., web server, user device, etc.). It should be noted that the end entity 16 may represent one or several end entities. Each of the root CA 12, one or more ICAs 14-1, . . . , 14-N, and end entity 16 may have a digital certificate (cert) associated therewith, establishing a certificate chain 18. Normally, to determine if a path is secure, the end entity 16 may perform a full chain validation process 20 that checks the validity of the certificate of each element of the certificate chain 18.

A Certificate Authority (CA) is an entity responsible for issuing and managing digital certificates that verify the authenticity and identity of entities (e.g., users, devices, organizations, etc.) on a network. The CA manages the certificate lifecycle, including the generation of keys and certificates, renewal or reissuance of certificates, and revocation of certificates. In some cases, the CA may publish Certificate Revocation Lists (CRLs) indicating what certificates have been revoked. The digital certificates are designed to maintain trust and to ensure that security components comply with or conform to best practices with respect to various standards and protocols.

The root CA 12 may be configured to server as a trust anchor, which is the ultimate trust authority in the certificate chain. The root CA 12 can issue and sign certificates to the ICAs 14-1, . . . , 14-N and also delegate the responsibility of certificate issuance to the end-entity 16. Normally, the root CA 12 may have minimal direct interaction with the end entity 16 or the public and is typically kept offline in the highly secured CA or network environment 10. Thus, the root CA 12 is rarely used to issue certificates to the end-entity 16 directly. The root CA 12 can provide key management, such as by generating and securely storing the root private key, which may be used in a controlled manner to sign ICA certificates or revocation lists.

The ICAs 14-1, . . . , 14-N may be configured to handle day-to-day issuance of certificates to the end entity 16 (or end-entities) and can reduce the workload and exposure of the root CA 12. The ICAs 14-1, . . . , 14-N may be configured to validate certificates, and verify the identity and credentials of certificate applicants before issuing certificates. Also, the ICAs 14-1, . . . , 14-N are configured to sign certificates for the end entities with their private keys. In addition, the ICAs 14-1, . . . , 14-N are configured to manage the Certificate Revocation Lists (CRLs) and manage Online Certificate Status Protocol (OCSP) responses for certificates they issue.

Because of the limited nature of the resource-constrained devices (e.g., end entity 16) and the need to accommodate evolving security requirements and certificate management practices, conventional systems inherently pose a barrier to maintaining security, compliance, and uninterrupted operations over the lifetime of the resource-constrained devices. However, to overcome these issues, the systems and methods of the present disclosure are configured to validate or verify the trust of the root CA 12 and one or more ICAs 14-1, . . . , 14-N using OCSP-based services for assisting resource-constrained devices.

### Centralized Certificate Validation Server

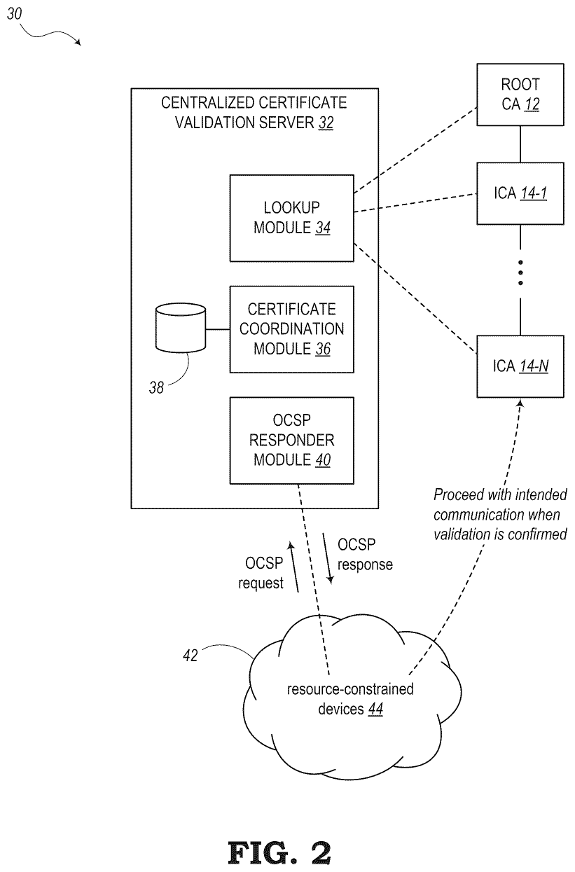

FIG. 2 is a block diagram illustrating an embodiment of a network system 30 for enhancing security. As shown, the network system 30 includes a centralized certificate validation server 32, which includes a lookup module 34, a certificate coordination module 36, a repository 38, and an OCSP responder module 40. The centralized certificate validation server 32 is configured to intercede for a domain 42 (or multiple network domains), which includes one or more resource-constrained devices 44. Instead of requiring each of the resource-constrained devices 44 to validate certificates and components (e.g., root CA 12, ICAs 14-1, . . . 14-N), as suggested with respect to FIG. 1, the resource-constrained devices 44 are assisted by the centralized certificate validation server 32. In this way, the limited resources of the resource-constrained devices 44 do not get in the way of ensuring proper security and validation.

It may be noted that the centralized certificate validation server 32 may include various components and functionality for assisting the resource-constrained devices 44 with determining validation. In one respect, the lookup module 34 of the centralized certificate validation server 32 may be configured to check the validity status of the root CA 12 and ICAs 14-1, . . . , 14-N associated with the specific domain 42 and periodically update the status as needed. The certificate coordination module 36 may be configured to manage the validity information and store an updated list of valid ICAs 14-1, . . . , 14-N in the repository 38.

The resource-constrained devices 44 (e.g., clients) can use an Online Certificate Status Protocol (OCSP) or other suitable protocol (e.g., SSL, TLS, etc.) for communicating with the centralized certificate validation server 32 to obtain validation information of the ICAs 14-1, . . . , 14-N with the intention of communicating via the ICAs 14-1, . . . , 14-N. As an example, if a resource-constrained device 44 is a smart TV and intends to communicate IoT-type information to a remote server, the action of checking the security of the communication paths can be performed initially to prevent security breaches. Thus, the resource-constrained device 44 initially sends an OCSP request to the OCSP responder module 40 of the centralized certificate validation server 32. The OCSP responder module 40 checks with the certificate coordination module 36 to verify the ICA/CA certificate trust status using the updated list in the repository 38 and provides an OCSP response back to the requesting client.

In one case, the client (e.g., resource-constrained device 44) can look up the validity of the certificates and ICAs themselves each time it intends to communicate data over the network. In an alternative case, the client can use a minimal amount of storage capabilities to cache the OCSP response. Then, it can use this response for a limited amount of time with the assumption that the status has not changed. When memory/storage permits, the client can get an update from the centralized certificate validation server 32.

The repository 38 may be configured to store an updated list of the certificates, certificate data, valid ICAs, and other pertinent data. Then, when an OCSP request is received, the OCSP responder module 40 can quickly consult with the certificate coordination module 36 and respond to the client. The stored list maintained by the certificate coordination module 36 may include of permitted ICAs 14 and CAs corresponding to the specific deployment with the specific domain 42. In some embodiments, the centralized certificate validation server 32 (and corresponding repository 38) may store the permitted ICAs/CAs and certificates for multiple domains in which constrained devices are deployed.

The OCSP response may include:
1) Response Status—indicates if the OCSP response itself is successful or if there was an error (e.g., malformed OCSP request, internal error, etc.).
2) Responder ID—identifies the OCSP responder (e.g., centralized certificate validation server 32, OCSP responder module 40, etc.).
3) Timestamp—indicating when the response was produced.
4) Status Information—status data for each certificate in the request, including:
   a) certificate's serial number
   b) certificate status (e.g., valid, good, revoked, expired, or unknown)
   c) time when the status was last updated
5) Signature—digitally signed by the OCSP responder to ensure authenticity and integrity.

The lookup service of the lookup module 34 may be set up and maintained for a specific domain (e.g., domain 42) or deployment environment. From the lookup service, the certificate coordination module 36 is configured to hold a trusted list of valid ICAs and root CAs. Instead of requiring each resource-constrained device 44 to perform a lookup for itself every time it intends to communication (e.g., over the Internet), the resource-constrained device 44 can query the centralized certificate validation server 32 to verify the trust status of any ICA/CA. For example, this check can be performed during a TLS handshake or signature verification process.

The OCSP responder module 40 is a customized solution responsible for providing real-time certificate status information (e.g., good, revoked, expired, unknown, etc.) for the ICAs and leaf certificates in question. In a sense, each resource-constrained device 44 may be “pinned” with respect to the OCSP responder module 40 to initially validate the status of communication paths before the actual transmission of device data to a remote server. This can provide a more thorough update of validation status information and allows the resource-constrained devices 44 to remain simple without the need to have memory capacity to store the status information of multiple ICAs locally, thereby reducing the memory overhead significantly.

The systems and methods of the present disclosure are configured with a lightweight client-side process. That is, each resource-constrained device 44 (e.g., IoT device) only needs to store a minimum amount of cryptographic material, such as a) a public certificate (and possibly key) for the custom OCSP responder module 40, and b) a simplified trust store (e.g., memory) for a single pinned base CA (e.g., ICA), a single pinned OCSP responder (e.g., OCSP responder module 40), a single pinned centralized certificate validation server (e.g., centralized certificate validation server 32), a small set of ICAs/root CAs, or other limited storage pointers. During communication, the resource-constrained device 44 queries the custom service to validate the chain (or at least the ICA or intermediate certificate) in near-real time, using OCSP. The device may cache the OCSP responses for as long as allowed by its memory/storage constraints or until the next update is required by policy.

The OCSP responder module 40 of the centralized certificate validation server 32 is configured to utilize the permitted ICA/CA list in the repository 38, which keeps a curated list of ICAs and corresponding statuses (e.g., valid, revoked, expired, etc.). The list is updated anytime new ICAs 14 are introduced or when existing ones are revoked. With respect to the security of the OCSP responder module 40, this module may be readily available within the network system 30, secure, and configured to scale with the number of incoming requests from various devices in the field. The OCSP responder module 40 may use best practices, like load balancing, caching, and secure hosting.

Again, the centralized certificate validation server 32 may be configured to handle one domain (e.g., domain 42) or multiple domains or deployments of other resource-constrained devices. If different deployments require their own sets of ICAs/CAs, the centralized certificate validation server 32 can be segmented or configured accordingly. Each segment or tenant can manage its own ICA list without affecting others.

The communication of the OCSP requests and OCSP responses may use various formats, protocols, etc. The OCSP response may typically contain one or more of the following fields:
A. Response Status, which indicates whether the OCSP response itself was successful, and which could also show errors (e.g., malformedRequest, internalError, tryLater, sigRequired, unauthorized, etc.).
B. Responder ID, which identifies the Custom OCSP Responder (could be the key hash or a name).
C. Timestamp indicating when the response was generated.
D. Responses, such as a list containing the status for each requested certificate. For each certificate:
   1) Serial Number—The unique identifier of the certificate.
   2) Certificate Status, such as i) good or valid, when the certificate is valid (not revoked or expired according to the service's records), ii) revoked, when the certificate has been explicitly revoked, iii) expired, when the certificate has reached its expiration date, and iv) unknown, when the service cannot determine the certificate's status.
   3) This Update/Next Update—Indicates the current validity period for this status.
   4) Revocation Time and Reason (if applicable)—Specifies when and why the certificate was revoked.
E. Signature, where the entire OCSP response is digitally signed to ensure authenticity and integrity. Also, the resource-constrained device uses the pinned public key of the responder (or the pinned root) to verify this signature.

In some implementations, there may be certain device-side hardware constraints, as mentioned above. The cryptographic operations for verifying the OCSP response signature may be within the processing capability of the resource-constrained device. Also, if the device is extremely constrained, the network system 30 may implement a policy that utilizes simplified algorithms (e.g., ECC-based certificates for smaller key sizes). In addition, the network system 30 may be configured such that the resource-constrained devices 44 can easily access the centralized certificate validation server 32 or OCSP responder module 40. In scenarios with intermittent connectivity, caching within the resource-constrained devices 44 may be an important design aspect. For mission-critical operations offline, the device might rely on a last-known-good cache until it can reconnect.

Another implementation detail of the network system 30 is the policy of Root of Trust and Key Rotation. The pinned root CA or responder certificate on the resource-constrained device (e.g., IoT device) may be carefully managed. If the key is compromised or needs to be rotated, an over-the-air or physical update mechanism can be used for updating or rotating keys. Regular audits and security patches may also be used to ensure that the root of trust remains valid.

Regarding scalability and redundancy, the network system 30 may include a load-balanced OCSP infrastructure, which may be configured to ensure high availability and quick response times for potentially large fleets of IoT devices. Also, geographic redundancy can minimize latency and mitigate single points of failure.

The centralized certificate validation server 32 of the network system 30 may be implemented to improve upon various aspect of the conventional systems used with respect to resource-constrained devices and IoT devices. For example, the network system 30 may allow for a Reduced Storage Overhead, whereby, instead of storing multiple ICAs locally at each resource-constrained device, which might quickly exceed the memory limits of devices, these device may now only need to store a root certificate or a trust anchor for the custom service. Hence, the devices can offload the heavy lifting of certificate chain verification and revocation checks to the centralized certificate validation server 32.

The certificate coordination module 36 of the centralized certificate validation server 32 may include certificate management functions. For example, when an ICA rolls over or is replaced for compliance or security reasons, the lookup module 34 may discover the change and inform the certificate coordination module 36 to update the repository 38 with the new ICA. The resource-constrained devices 44 may continue to trust the custom service's root key, allowing them to seamlessly recognize and validate the new ICA without direct updates to the device's firmware or trust store.

Another novel aspect of the present disclosure involves a Real-Time Revocation Checking function of the centralized certificate validation server 32. A traditional IoT device deployment within a network environment often relies on static Certificate Revocation Lists (CRLs), which can be large and must be updated frequently. The OCSP responder module 40 can provide a more dynamic mechanism where the device can obtain the current status of a certificate or ICA on demand, only retrieving minimal data.

Another novel aspect involves Flexible Caching functionality of the centralized certificate validation server 32. For example, if network usage or power constraints are tight, the IoT device can cache the OCSP response for a set duration, which can be defined by a “Next Update” field in the OCSP response. This caching mechanism allows for fewer lookups while still maintaining up-to-date revocation or validity information.

A benefit of the systems and methods of the present disclosure with respect to conventional systems is that the network system 30 may include a simple design for the client (e.g., domain 42 deployed with various devices). Thus, various certificate management resources can be offloaded to the centralized certificate validation server 32. Also, the centralized certificate validation server 32 can provide Up-to-Date Trust, whereby changes (e.g., new ICAs, revoked ICAs, etc.) can be instantly reflected without firmware updates on the resource-constrained devices 44 themselves. Another advantage is the Reduced Memory Footprint, where only the essential cryptographic keys and minimal data need to be stored on the client device.

Therefore, a custom CA/ICA lookup service can be integrated in a custom OCSP responder system and can provide a centralized, efficient mechanism for constrained devices to validate certificates without needing to store and manage multiple ICAs locally. By relying on real-time (or near-real-time) status checks and caching mechanisms, the constrained devices (client or IoT endpoints) can maintain secure communication channels despite their limited resources. This design not only addresses the challenge of limited storage and computing power for certificate management systems, but also simplifies the process of handling ICA rollovers, revocations, and updates in a dynamic security environment.

### Computing System

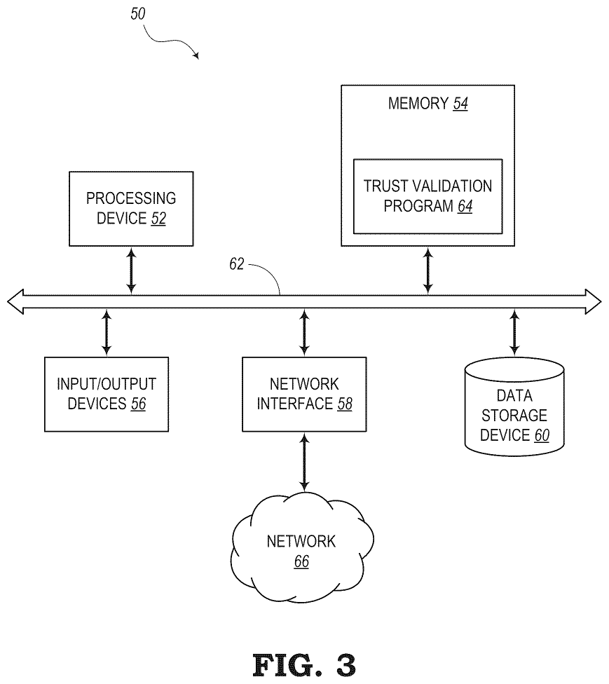

FIG. 3 is a block diagram illustrating an embodiment of a computing system 50, which may represent the centralized certificate validation server 32 shown in FIG. 2 or other certificate status system for determining trust or validation status of communication paths or components in a CA environment. In other embodiments, the computing system 50 of FIG. 3 may also represent a resource-constrained device (e.g., embedded device, IoT device, etc.), which may include a more simplified version with limited or restricted memory and processing capabilities. Thus, in some implementations, one version of the computing system 50 may represent the centralized certificate validation server 32, while another (simpler) version may represent one or more of the resource-constrained devices 44.

The computing system 50 may be a digital computer that, in terms of hardware architecture, generally includes a processing device 52, a memory device (memory 54), input/output (I/O) devices 56 (optional in IoT devices), a network interface 58, and a data storage device 60. It should be appreciated by those of ordinary skill in the art that FIG. 3 depicts the computing system 50 in an oversimplified manner, and a practical embodiment may include additional components and suitably configured processing logic to support known or conventional operating features that are not described in detail herein. The components (52, 54, 56, 58, 60) are communicatively coupled via a local interface 62. The local interface 62 may be, for example, but not limited to, one or more buses or other wired or wireless connections, as is known in the art. The local interface 62 may have additional elements, which are omitted for simplicity, such as controllers, buffers (caches), drivers, repeaters, and receivers, among many others, to enable communications. Further, the local interface 62 may include address, control, and/or data connections to enable appropriate communications among the aforementioned components.

The processing device 52 is a hardware device for executing software instructions. The processing device 52 may be any custom made or commercially available processor, a Central Processing Unit (CPU), an auxiliary processor among several processors associated with the computing system 50, a semiconductor-based microprocessor (in the form of a microchip or chipset), or generally any device for executing software instructions. When the computing system 50 is in operation, the processing device 52 is configured to execute software stored within the memory 54, to communicate data to and from the memory 54, and to generally control operations of the computing system 50 pursuant to the software instructions. The I/O devices 56 may be used to receive user input from and/or for providing system output to one or more devices or components.

The network interface 58 may be used to enable the computing system 50 to communicate on a network, such as the Internet. The network interface 58 may include, for example, an Ethernet card or adapter or a Wireless Local Area Network (WLAN) card or adapter. The network interface 58 may include address, control, and/or data connections to enable appropriate communications on the network. A data storage device 60 (e.g., one or more databases, data stores, etc.) may be used to store data. The data storage device 60 may include volatile memory elements (e.g., random access memory (RAM, such as DRAM, SRAM, SDRAM, and the like)), nonvolatile memory elements (e.g., ROM, hard drive, tape, CDROM, and the like), and combinations thereof.

Moreover, the data storage device 60 may incorporate electronic, magnetic, optical, and/or other types of storage media. In one example, the data storage device 60 may be located internal to the computing system 50, such as, for example, an internal hard drive connected to the local interface 62 in the computing system 50. Additionally, in another embodiment, the data storage device 60 may be located external to the computing system 50 such as, for example, an external hard drive connected to the I/O devices 56 (e.g., SCSI or USB connection). In a further embodiment, the data storage device 60 may be connected to the computing system 50 through a network, such as, for example, a network-attached file server.

The memory 54 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 54 may incorporate electronic, magnetic, optical, and/or other types of storage media. Note that the memory 54 may have a distributed architecture, where various components are situated remotely from one another but can be accessed by the processing device 52. The software in memory 54 may include one or more software programs, each of which includes an ordered listing of executable instructions for implementing logical functions. The software in the memory 54 includes a suitable Operating System (O/S) and one or more programs. The O/S essentially controls the execution of other computer programs, such as the one or more programs, and provides scheduling, input-output control, file and data management, memory management, and communication control and related services. The one or more programs may be configured to implement the various processes, algorithms, methods, techniques, etc. described herein.

The computing system 50 further includes a trust validation program 64 that may be implemented in any suitable combination of hardware (e.g., configured in the processing device 52) and/or software/firmware (e.g., configured in the memory 54). The trust validation program 64 may be stored in any suitable non-transitory computer-readable media (e.g., the memory 54) and may include computer logic or code having instructions that enable or cause the processing device 52 to perform certain actions as discussed in the present disclosure.

Of note, the general architecture of the computing system 50 can define any device described herein. However, the computing system 50 is merely presented as an example architecture for illustration purposes. Other physical embodiments are contemplated, including virtual machines (VM), software containers, appliances, network devices, and the like.

In an embodiment, the various techniques described herein can be implemented via a cloud service. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. The phrase “Software as a Service” (SaaS) is sometimes used to describe application programs offered through cloud computing. A common shorthand for a provided cloud computing service (or even an aggregation of all existing cloud services) is “the cloud.”

With respect to the centralized certificate validation server 32, the trust validation program 64 may be configured to perform many (or all) of the functions of the lookup module 34, certificate coordination module 36, repository 38, and OCSP responder module 40, as described in the present disclosure. With respect to each of the constrained devices, the trust validation program 64 may include simplified functionality, as described in the present disclosure, for relying on the centralized certificate validation server 32 when needed to obtain up-to-date status information of certification data related to communications associated with supplying a remote server with operational data of the device in which the constrained device may be embedded.

### General Method for Validating Digital Certificates and ICAs

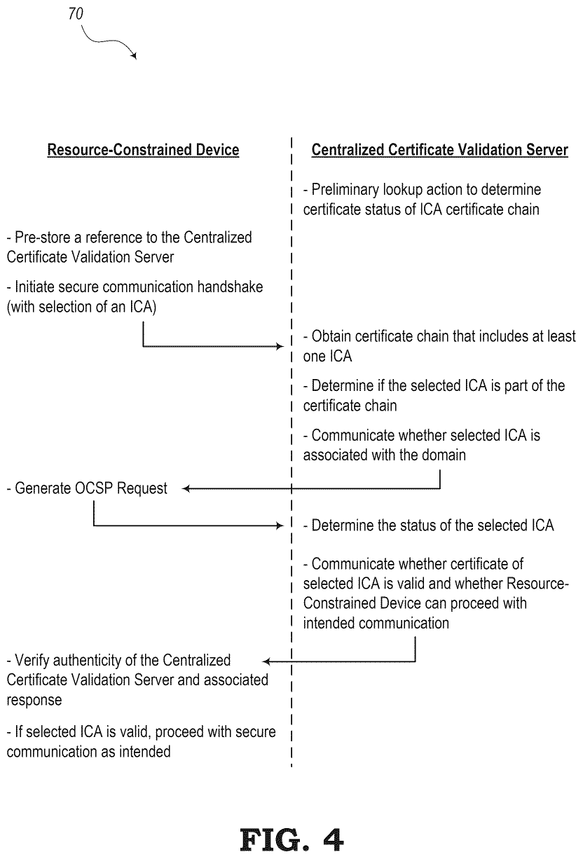

FIG. 4 is a flow diagram illustrating an embodiment of a method 70 for validating digital certificates in a network having resource-constrained devices. The method 70 includes the operations of both a resource-constrained device (e.g., one of the resource-constrained device 44 described with respect to FIG. 2) and the centralized certificate validation server 32 (or other certificate status verification system).

As shown, a first step (or pre-step) may include a preliminary lookup action by the centralized certificate validation server to determine the current certificate status of the certificate chain 18 associated with a network domain being serviced. The lookup action may include an ongoing process for updating the certificate status based on changes in the network (e.g., expiration of certificates, revocation of certificates, removal or addition of an ICA in the system, etc.). Another preliminary or initial step may include the pre-storing of a reference to a corresponding centralized certificate validation server in a trust store of each of resource-constrained devices being configured to perform the certificate validation procedures described in the present disclosure. The reference pre-storing step may be performed during manufacturing of an IoT device or other constrained device with respect to a corresponding certificate status detection device that is designed to operate with a group of constrained or IoT devices. In other embodiments, the pre-storing of the reference may be performed when the constrained device is deployed in a specific domain (e.g., domain 42) where the centralized certificate validation server is also deployed for being responsible for the trust services described herein.

The method 70 further includes a step where the resource-constrained device initiates a secure communication handshake action. This may also involve a selection of an ICA from which the certificate status is needed for communication with this ICA. In response to receiving the handshaking request, the centralized certificate validation server is configured to obtain information about a certificate chain that includes at least one ICA associated with the domain in which the constrained device is deployed. The centralized certificate validation server is next configured to determine if the selected ICA is part of the certificate chain. Then, a handshaking response is sent back to the constrained device to communicate whether the selected ICA is associated with the specific domain.

After these handshaking steps, the resource-constrained device is then able to generate an OCSP request to determine the validity of the certificate and ICA of question. The OCSP request is sent to the centralized certificate validation server. Upon receiving the OCSP request, the centralized certificate validation server is configured to determine the status of the selected ICA. For example, this may include a preliminary lookup stage in which the ICAs and root CA are analyzed to determine their status. The obtained information can be stored in the repository 38. After determining the status of the selected ICA, the centralized certificate validation server is configured to communicate whether the certificate of the selected ICA is valid and whether the resource-constrained device can proceed with the intended communications involving this selected ICA.

The resource-constrained device receives the response (e.g., OCSP response) from the centralized certificate validation server and verifies the authenticity of the centralized certificate validation server. It also can verify the associated response. If the OCSP response is legitimate and comes from a legitimate source, then the resource-constrained device knows whether the selected ICA is valid or not. If it is valid, then the resource-constrained device can proceed with the secure communication as intended.

In some embodiments, the interaction between the resource-constrained device and the centralized certificate validation server may include the following stages, which may include similarities to the method 70 of FIG. 4.
A. Constrained Device Bootstrapping—During manufacturing or initial provisioning, each constrained device may be programmed with a small trust store (e.g., memory) that is configured to include the public key (certificate) of the centralized certificate validation server, custom OCSP responder, pinned root CA, etc. associated with the domain in which the constrained device is deployed.
B. Session Initialization—The constrained device initiates a secure communication session (e.g., TLS handshake) with the centralized certificate validation server, or the like, in order to verify a digital signature that references a specific ICA.
C. ICA Verification Request—Upon receiving the server's certificate chain (or signature), the constrained device identifies the intermediate certificate. Also, the constrained device constructs an OCSP request and sends it to the OCSP responder module 40 through the designated lookup endpoint (e.g., “ocsp.example.com”).
D. Lookup Service Processing—The centralized certificate validation server (e.g., OCSP responder, backed by the Central Lookup Service) is configured to check against its local list of trusted and valid ICAs/CAs. It then issues an OCSP response indicating whether the requested certificate is good (valid), revoked, expired, or unknown.
E. OCSP Response Delivery—The response may be digitally signed by the OCSP responder, leveraging its private key. The signed response is sent back to the constrained device.
F. Device Validates OCSP Response—The constrained device verifies the signature of the OCSP response using the pinned certificate of the custom OCSP responder (or via the pinned root CA). If the response is valid and the certificate status is good, the device proceeds with the communication. If the certificate is revoked or unknown, the device terminates or flags the session.
G. Caching (Optional)—The constrained device may store the OCSP response until the Next Update timestamp or until its memory constraints trigger eviction. When the cached information expires, the device repeats the OCSP request to maintain up-to-date certificate status.

### Functional Operations of the Centralized Certificate Validation Server

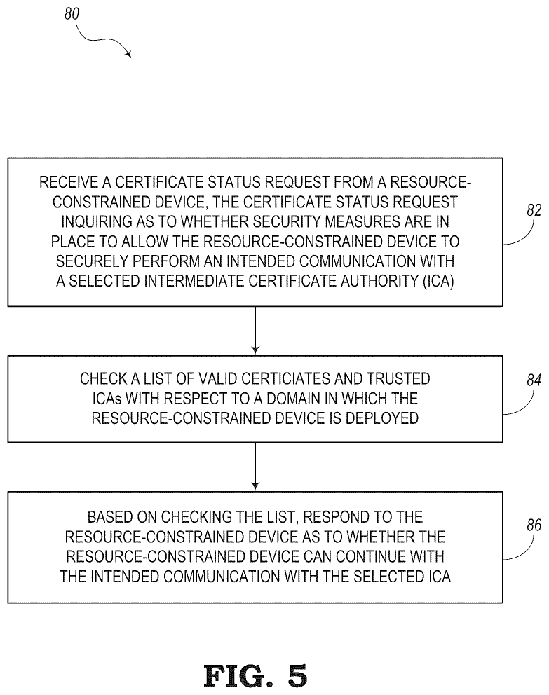

FIG. 5 is a flow diagram illustrating an embodiment of a method 80 to be performed by a centralized certificate validation server (e.g., the centralized certificate validation server 32 shown in FIG. 2). As shown, the method 80 includes a step of receiving a certificate status request from a resource-constrained device, as indicated in block 82. Specifically, the certificate status request inquires as to whether security measures are in place to allow the resource-constrained device to securely perform an intended communication with a selected Intermediate Certificate Authority (ICA). In addition, the method 80 includes a step of checking a list of valid certificates and trusted ICAs with respect to a domain in which the resource-constrained device is deployed, as indicated in block 84. Based on the step of checking the list, the method 80 further includes a step of responding to the resource-constrained device as to whether the resource-constrained device can continue with the intended communication with the selected ICA, as indicated in block 86.

According to various embodiments of the method 80, the certificate status request may be related to an Online Certificate Status Protocol (OCSP) call. In some embodiments, the method 80 may further include a step of performing a preliminary lookup action to determine the certificate status of a certificate chain associated with a root Certificate Authority (root CA) and one or more ICAs configured for servicing the domain. The method 80 may also include a step of storing information obtained during the preliminary lookup action in a repository that is configured to record the list of valid certificates and trusted ICAs. The method 80 may also include a step of performing periodic updated lookup actions to update the certificate status of the certificate chain.

The certificate status request, for example, may be part of a Transport Layer Security (TLS) communication. Also, the step of checking the list may be performed independently of a Certificate Revocation List (CRL). The method 80 may further include a step of checking whether the selected ICA is part of the domain in which the resource-constrained device is deployed. The action of responding to the resource-constrained device may thereby allow the resource-constrained device to validate multiple PKI handshakes, signatures, or certificate chains. The method 80 of FIG. 5, according to some embodiments, may be implemented by the centralized certificate validation server 32, which may include a lookup module, a certificate coordination module, and an Online Certificate Status Protocol (OCSP) responder module (e.g., as shown in FIG. 2). The step of responding to the resource-constrained device, according to some embodiments, may include digitally signing a certificate validation response to ensure integrity and authenticity.

### Functional Operations of One of the Resource-Constrained Devices

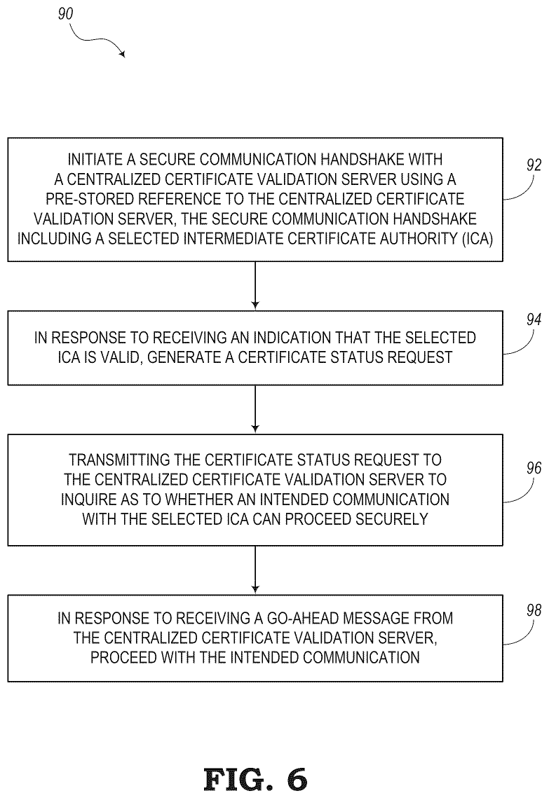

FIG. 6 is a flow diagram illustrating an embodiment of a method 90 to be performed by a resource-constrained device (e.g., one of the resource-constrained devices 44 shown in FIG. 2) that may be deployed within a specific network domain. As shown, the method 90 includes a step of initiating a secure communication handshake with a centralized certificate validation server using a pre-stored reference to the centralized certificate validation server, as indicated in block 92, whereby the secure communication handshake includes a selected Intermediate Certificate Authority (ICA). In response to receiving an indication that the selected ICA is valid, the method 90 further includes a step of generating a certificate status request. The method 90 also includes transmitting the certificate status request to the centralized certificate validation server to inquire as to whether an intended communication with the selected ICA can proceed securely, as indicated in block 96. In response to receiving a go-ahead message from the centralized certificate validation server, the method 90 further includes a step of proceeding with the intended communication, as indicated in block 98.

According to various implementations of the method 90, the certificate status request may be related to an Online Certificate Status Protocol (OCSP) call. The centralized certificate validation server, for example, may be configured to generate the go-ahead message in response to determining a certificate status of a certificate chain associated with a root Certificate Authority (root CA) and one or more ICAs during a preliminary lookup procedure and/or during one or more updated lookup procedures. In some embodiments, the certificate status request may be generated independently of a Certificate Revocation List (CRL). The method 90, according to some embodiments, may include a step of validating multiple PKI handshakes, signatures, or certificate chains. The method 90 may also include a step of using the pre-stored reference to verify the authenticity of the indication that the selected ICA is valid.

In some embodiments, the method 90 may be performed by any resource-constrained device for executing the validation procedures described in the present disclosure. In various implementations, the resource-constrained device may include a trust store that is configured to store the pre-stored reference to pin a root certificate or public key to the centralized certificate validation server. Furthermore, in some embodiments, the method 90 may include a) caching the go-ahead message for a specified period of time, and b) discarding the cached response when the specified period of time has elapsed or when memory constraints are reached. The method 90, in some cases, may further include verifying the authenticity of a) the indication that the selected ICA is valid and/or b) the go-ahead message. For example, this verifying of the authenticity may be performed by 1) retrieving an identifier of the centralized certificate validation server, 2) confirming that the identifier matches a pre-stored OCSP responder identifier, and 3) validating a digital signature applied to the centralized certificate validation server using a pinned certificate or public key stored in a trust store in the resource-constrained device.

According to additional embodiments, the method 90 may further includes updating the pinned root certificate or public key for the custom OCSP responder on the constrained IoT device via an over-the-air (OTA) or physical update mechanism when the custom OCSP responder's certificate is rotated, replaced, or compromised. The method 90 may also include generating a revocation check for the ICA at defined intervals or upon each handshake, allowing the constrained IoT device to identify any newly revoked ICA without storing a full Certificate Revocation List (CRL). Furthermore, the constrained device performing the method 90 may be configured to operate with limited memory and leverage ephemeral storage to retain only the most recent OCSP responses. Also, the constrained device may perform cryptographic operations using a lightweight algorithm, such as elliptic curve cryptography, to fit within its limited processing capability.

In some alternative embodiments, a method for managing the rollover of an ICA on a constrained (IoT) device using a centralized lookup service may include a step of pinning a root certificate or public key for a custom OCSP responder on the constrained IoT device, thereby establishing a single trust anchor. This method may also include receiving at the centralized lookup service a newly issued ICA intended to replace an existing ICA and then updating records in the custom OCSP responder to reflect trust in the newly issued ICA. This method may also include steps of publishing the updated trust information to the centralized lookup service, and then responding, by the custom OCSP responder, to any OCSP queries from constrained IoT devices, indicating that the newly issued ICA is in good standing. Furthermore, this method may include a step of facilitating continued secure communications for constrained IoT devices without requiring each device to store or update the new ICA locally.

According to this additional method, the constrained device may further be configured to mark the replaced ICA as revoked or retired within the custom OCSP responder's records. Also, this method may include issuing OCSP responses that reflect the updated status of the replaced ICA to prevent constrained IoT devices from establishing trust with it. Then, the method may include enabling immediate revocation or deprecation of the replaced ICA without requiring a direct certificate store update on each constrained IoT device.

### Additional Considerations

The present disclosure may be directed to systems and methods for ICA/CA trust validation using OCSB-based services for constrained devices. One aspect of digital certificates that is typically considered is the obtaining of knowledge with respect to whether or not a certificate is valid. A validation check may include determining that the certificate has neither expired nor been revoked. A first way to do this is by using what is normally referred to as a Certificate Revocation List (CRL), which is normally published on a regular basis by a Content Delivery Network (CDN). If a device wishes to determine if a certificate has expired, it can basically check the serial number from the CRL.

Another way of checking validity (e.g., consistent with the systems and methods described in the present disclosure) is by using an Online Certificate Status Protocol (OCSB). When a device wishes to request information regarding the validity of a certificate, the device can basically make an OCSP call. Although OCSP is generally being phased out in public trust systems (e.g., for websites), this protocol may still be a viable choice for private trust applications.

One problem, however, is that constrained devices (e.g., IoT devices, embedded devices, etc.) rarely obtain information from these OCSP calls for the sake of ensuring that its ICA and related certificate that it is immediately connected to, after a client certificate, is valid. In order to determine if the certificate is valid, the device would need to check the full chain validation 20. However, this normally becomes very costly for an embedded device or an IoT device. Instead of looking up validity from a list (i.e., CRL), a bunch of OCSP calls may be needed. However, since the client devices (e.g., resource-constrained devices) are not normally capable of querying for CRL, the implementations described in the present disclosure are utilized to overcome the hurdles of the conventional systems (e.g., limited capabilities of resource-constrained devices, etc.).

The OCSP allows a device (even a limited capacity device) to use a real-time API that allows it to make a simplified query to a centralized server to get the status of the certificates and ICAs. Also, since the status may only be valid for a certain time, the centralized server can get frequent updates, with certificate updates normally signed by the CA. The OCSP responder (e.g., OCSP responder module 40 of the centralized certificate validation server 32) can sign the certificates and record available status updates in the repository 38 for the client devices within the domain 42. In some embodiments, the centralized certificate validation server 32 may be configured to publish a list, referred to herein as an OCSP list, similar to the CRL, for access by domain-implemented device.

For example, the client device can make a TLS request and can tell the centralized certificate validation server 32 that also provide an OCSP status as well. In that case, the server will go to the repository 38 and ask for the OCSP status for the relevant certificate. This may be referred to as a “stapling” procedure in which that OCSP status is stapled along with the certificate when the client is doing the handshake. The client device can look at the OCSP status to know whether or not the certificate is valid. If not, the device does not need to go through the whole CRL.

Since each certificate may have a size of about 3 kB, a resource-constrained device may not have enough memory space to store multiple certificates. Therefore, by utilizing the procedures described herein, the device can instead rely on the resources of a centralized server that can act on behalf of many constrained devices. In this way, each individual client device does not have to be needlessly expanded to accomplish an outcome that can be provided by a single server. Also, each individual device can easily communicate with the centralized server to access the certificate status information as needed.

A certificate authority is an entity that stores, signs, and issues digital certificates. This allows others (relying parties) to rely upon signatures or on assertions made about the private key that corresponds to the certified public key. A CA acts as a trusted third party—trusted both by the subject (owner) of the certificate and by the party relying upon the certificate. For certificate authorities, existing individual validation processes involve the use of third-party verification services to validate basic individual information such as first name, last name, professional title, etc. However, these processes do not include the option to validate and incorporate an individual's crypto wallet address. As cryptocurrency becomes more prevalent, there is an increasing need for a secure, verified method of associating crypto wallet addresses with individuals.

X.509 certificates are defined by ITU X.509, Information technology—Open Systems Interconnection—The Directory: Public-key and attribute certificate frameworks, October 2019, the contents of which are incorporated by reference in their entirety. An X.509 certificate binds an identity to a public key using a digital signature. A certificate contains an identity (a hostname, or an organization, or an individual) and a public key (e.g., RSA, DSA, ECDSA, ed25519, etc.), and is signed by a certificate authority. X.509 also defines certificate revocation lists, which are a means to distribute information about certificates that have been deemed invalid by a signing authority, as well as a certification path validation algorithm, which allows for certificates to be signed by intermediate CA certificates, which are, in turn, signed by other certificates, eventually reaching a trust anchor. When a certificate is signed by a trusted certificate authority, or validated by other means, someone holding that certificate can use the public key it contains to validate documents or content digitally signed by the corresponding private key.

In an embodiment, an X.509 certificate can be used to digitally sign content. A content signing certificate allows individuals, teams, and organizations to add an electronic, digital signature to a document or other content in a variety of file formats to prove ownership. The digital signature is an encrypted hash of your message that can only be decrypted by someone who has a copy of your public key, which ensures (1) content stays unaltered, (2) the creator's identity is confirmed, and the like.

A digital signature cryptographically binds a digital signature certificate, issued by a trust services provider (TSP), to a document using public key infrastructure (PKI) technology. Digital signatures validate and authenticate signer identity and document integrity, delivering higher levels of assurance that the signer is who they say they are and that the document has not been altered. Digital signatures are ideal for transactions that require higher level of security and are necessary in certain countries and regions where companies are required to comply with legal regulations. In some countries, some forms of digital signatures have legal validity equivalent to handwritten signatures.

In another embodiment, the X.509 certificate can be referred to as a personal certificate, i.e., it does not necessarily need to be used to digitally sign content. In a further embodiment, the X.509 certificate can be a content credential that includes history and identity data attached to content. A user can view this data when a creator or producer has attached it to content to understand more about what has been done to it, where it has been, and who is responsible. Content credentials are public and tamper-evident, and can include info like edits and activity, assets used, identity info, and more.

### Conclusion

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each potentially equipped with one or more processors. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. Additionally, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

What is claimed is:

1. A centralized certificate validation server configured to:
receive a certificate status request from a resource-constrained device, the certificate status request inquiring as to whether security measures are in place to allow the resource-constrained device to securely perform an intended communication with a selected Intermediate Certificate Authority (ICA);
check a list of valid certificates and trusted ICAs with respect to a domain in which the resource-constrained device is deployed; and
based on checking the list, respond to the resource-constrained device as to whether the resource-constrained device can continue with the intended communication with the selected ICA.

2. The centralized certificate validation server of claim 1, wherein the certificate status request is related to an Online Certificate Status Protocol (OCSP) call.

3. The centralized certificate validation server of claim 1, further configured to perform a preliminary lookup action to determine a status of a certificate chain associated with a root Certificate Authority (root CA) and one or more ICAs configured for servicing the domain.

4. The centralized certificate validation server of claim 3, further configured to store information obtained during the preliminary lookup action in a repository that is configured to record the list of valid certificates and trusted ICAs.

5. The centralized certificate validation server of claim 3, further configured to perform periodic updated lookup actions to update a status of the certificate chain.

6. The centralized certificate validation server of claim 1, wherein the certificate status request is part of a Transport Layer Security (TLS) communication.

7. The centralized certificate validation server of claim 1, wherein checking the list of valid certificates is performed independently of a Certificate Revocation List (CRL).

8. The centralized certificate validation server of claim 1, further configured to check whether the selected ICA is part of the domain in which the resource-constrained device is deployed.

9. The centralized certificate validation server of claim 1, wherein responding to the resource-constrained device allows the resource-constrained device to validate multiple PKI handshakes, signatures, or certificate chains.

10. The centralized certificate validation server of claim 1, comprising at least a lookup module, a certificate coordination module, and an Online Certificate Status Protocol (OCSP) responder module.

11. The centralized certificate validation server of claim 1, wherein responding to the resource-constrained device includes digitally signing a certificate validation response to ensure integrity and authenticity.

12. A resource-constrained device deployed within a network domain, the resource-constrained device configured to:
initiate a secure communication handshake with a centralized certificate validation server using a pre-stored reference to the centralized certificate validation server, the secure communication handshake including a selected Intermediate Certificate Authority (ICA);
in response to receiving an indication that the selected ICA is valid, generate a certificate status request;
transmitting the certificate status request to the centralized certificate validation server to inquire as to whether an intended communication with the selected ICA can proceed securely; and
in response to receiving a go-ahead message from the centralized certificate validation server, proceed with the intended communication.

13. The resource-constrained device of claim 12, wherein the certificate status request is related to an Online Certificate Status Protocol (OCSP) call.

14. The resource-constrained device of claim 12, wherein the centralized certificate validation server is configured to generate the go-ahead message in response to determining a certificate status of a certificate chain associated with a root Certificate Authority (root CA) and one or more ICAs during a preliminary lookup procedure and/or during one or more updated lookup procedures.

15. The resource-constrained device of claim 12, wherein the certificate status request is generated independently of a Certificate Revocation List (CRL).

16. The resource-constrained device of claim 12, further configured to validate multiple PKI handshakes, signatures, or certificate chains.

17. The resource-constrained device of claim 12, further configured to use the pre-stored reference to verify authenticity of the indication that the selected ICA is valid.

18. The resource-constrained device of claim 12, comprising a trust store configured to store the pre-stored reference to pin a root certificate or public key to the centralized certificate validation server.

19. The resource-constrained device of claim 12, further configured to:
cache the go-ahead message for a specified period of time; and
discard the go-ahead message when the specified period of time has elapsed or when memory constraints are reached.

20. The resource-constrained device of claim 12, further configured to verify authenticity of a) the indication that the selected ICA is valid and/or b) the go-ahead message, by:
retrieving an identifier of the centralized certificate validation server;
confirming that the identifier matches a pre-stored OCSP responder identifier; and
validating a digital signature applied to the centralized certificate validation server using a pinned certificate or public key stored in a trust store in the resource-constrained device.
